(19) United States
(12) Patent Application Publication
(10) Pub. No.: US 2006/0004834 A1
(43) Pub. Date: Jan. 5, 2006

(54) Dynamic shortcuts

(75) Inventors: Seppo Pyhalammi, Helsinki (FI); Kaj Haggman, Espoo (FI); Jouni Soitinaho, Espoo (FI); Tuomo Sihvola, Espoo (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/881,393

(22) Filed: Jun. 30, 2004

(51) Int. Cl. G06F 17/00

(52) U.S. Cl. 707/102

(57) ABSTRACT

The invention provides searching, accessing, maintaining, or editing of media files using a remote control device having a display. The invention enables a user to manipulate displayed media files and other types of information stored on a server. The server may be coupled to a display device such as a television receiver and to a remote control device also having a display. A user, through the remote control device, may manipulate media files through the use of buttons displayed on the remote control device. The buttons of the remote control device may be associated with executable commands to be performed on the media files. The modified media files may be displayed on both the television receiver and the remote control device to improve a user's ability to modify the media files.

### FIELD OF THE INVENTION

Aspects of the present invention relate generally to searching, accessing, maintaining, or editing digital information using a remote control device having a display. More specifically, aspects of the present invention concern sharing a user interface between two or more devices such as a receiver and a remote control device in order to provide a convenient way for a user to browse, select, or edit displayed media files.

### BACKGROUND OF THE INVENTION

A variety of mobile computing devices exist, such as personal digital assistants (PDAs), mobile phones, digital cameras, digital players, mobile terminals, etc. (hereinafter referred to as “mobile devices”). These devices perform various functions specific to the device, and are often able to communicate (via wired or wireless connection) with other devices. A single mobile device may, for example, provide Internet access, maintain a personal calendar, provide mobile telephony, and take digital photographs. However, memory capacity is typically limited on mobile devices. Wireless telephones and other mobile devices that create digital photographs, video segments and audio segments must store those segments. Storage of these items usually requires a relatively large amount of memory. Moreover, mobile devices are often not optimized for later viewing and enjoyment of image collections. The display screens on mobile devices are often small and have limited resolution. The small display screens also present difficulties when more than one person wishes to simultaneously view images.

One solution to these challenges is to transfer files to other devices, such as a remotely-located personal computer or dedicated storage equipment. A user may, for example, use a mobile device to create images such as photographs, and periodically transfer those images to a server or other storage device located in the user's home or elsewhere. The images may be displayed on a receiver such as a television set for viewing. In this manner, the number of images a user may create (and retain) is not limited by the memory constraints of his or her mobile device. In addition, the images or photographs may be displayed on a larger and higher resolution display.

However, the above solution creates additional challenges as users can now easily create and store numerous images. Users must manipulate a much larger number of images which increases the number of input commands such as key strokes that a user must enter to search, access, or edit the created images. In addition, a user must constantly share their attention between the television screen to view the images and the mobile device used to enter commands which is distracting and inefficient.

For example, a user is often required to manipulate images such as rotating or enlarging images for proper viewing on a display. Manipulating these images requires a user to perform a number of separate keystrokes for each image including the issuing of a save command to save each manipulated image. In addition, in order to manipulate each of these images a user must constantly share their attention between the display device and the remote control device in order to properly enter each of the input commands.

For these and other reasons, there remains a need for a system and method by which a user can more conveniently manipulate images and other displayed media files.

### SUMMARY OF THE INVENTION

Aspects of the present invention are directed to allowing a user to manipulate displayed media files and other types of information stored on a server. The server may be coupled to a display device such as a television receiver and to a remote control device also having a display. A user, through the remote control device, may manipulate media files through the use of buttons displayed on the remote control device. The buttons of the remote control device may be associated with executable commands to be performed on the media files. The executable commands may be substantially simultaneously displayed on both the television receiver and the remote control device to improve a user's ability to modify the media files.

These and other features of the invention will be apparent upon consideration of the following detailed description of preferred embodiments.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 is a block diagram of an example of a wireless communication system in which various aspects of the present invention may be implemented.

FIG. 2 is a block diagram of an illustrative remote control device in accordance with an aspect of the present invention.

FIG. 3 is a block diagram of a server in accordance with an aspect of the present invention.

FIG. 4 shows a configuration for manipulating media files in accordance with an aspect of the present invention.

FIG. 5 show various screens of media application in accordance with an aspect of the present invention.

FIG. 6 shows a remote control device and an enlargement of an image displayed on the remote control device in accordance with an aspect of the present invention.

FIG. 7 shows a system for interacting with and manipulating media files with an enlargement of a second image displayed on both a remote control device and on a display device in accordance with an aspect of the present invention.

FIG. 8 shows a system for interacting with media files in accordance with an aspect of the present invention.

FIG. 9 show a system for interacting with media files in accordance with another aspect of the present invention.

### DETAILED DESCRIPTION OF THE PREFERRED EMBODIMENTS

Example Operating Environment

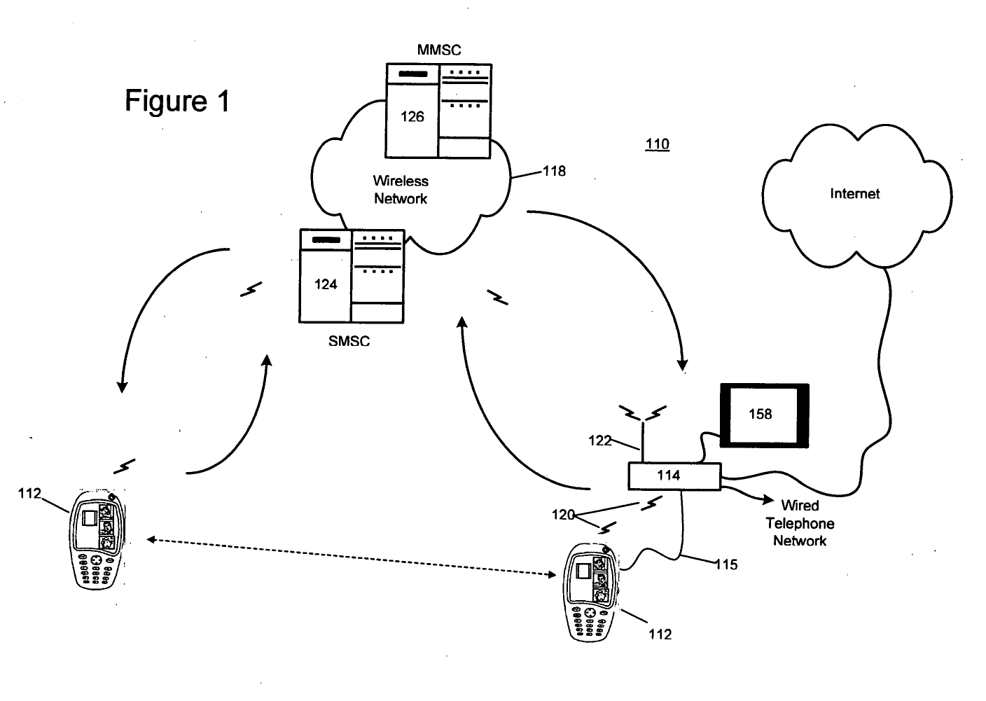

FIG. 1 shows an example of a wireless communication system 110 in which the systems and methods of the present invention may be advantageously employed. One or more network-enabled remote control or input devices 112, such as a personal digital assistant (PDA), digital camera, cellular phone, mobile terminal, television, PC monitor, LCD projector, head display, or combinations thereof, is in communication with a server 114. Although not shown in FIG. 1, server 114 may act as a file server, such as a personal server or personal storage device, for a network such as home network, some other Local Area Network (LAN), or a Wide Area Network (WAN).

Server 114 may be a computer, laptop, set-top box, DVD, television, PVR, DVR, TiVo device, personal portable server, personal portable media player, network server or other device capable of storing and accessing data. Mobile device 112 may communicate with server 114 in a variety of manners. For example, remote control device 112 may communicate with server 114 via wireless network 118. Wireless network 118 may be a third-generation (3G) cellular data communications network, a Global System for Mobile communications network (GSM), or other wireless communication network. Remote control device 112 may also have one or more ports allowing a wired connection to server 114 via, e.g., universal serial bus (USB) cable 115. Remote control device 112 may also be capable of short-range wireless connection 120 (e.g., a BLUETOOTH, WLAN, WiFi or IrDA link) to server 114. A single remote control device 112 may be able to communicate with server 114 in multiple manners.

Server 114 may act as a repository for storing files received from remote control device 112 and from other sources. Server 114 may have, or be coupled to, a wireless interface 122 configured to transmit and/or receive communications (such as messages, files, or other data) with mobile network 118 or WLAN network. Server 114 may alternatively (or also) have one or more other communication network connections. For example, server 114 may be linked (directly or via one or more intermediate networks) to the Internet, to a conventional wired telephone system, or to some other communication or broadcasting network, such as a TV, a radio or IP datacasting networks.

In one embodiment, remote control device 112 has a wireless interface configured to send and/or receive digital wireless communications within wireless network 118. As part of wireless network 118, one or more base stations (not shown) may support digital communications with remote control device 112 while the remote control device is located within the administrative domain of wireless network 118. The base station of wireless network 118 that is in communication with remote control device 112 may be the same or a different base station that is in communication with server 114. Indeed, remote control device 112 and server 114 may each be in communication with different wireless networks (e.g., remote control device 112 could be roaming), which could in turn be interlinked via one or more intermediate wired or wireless networks. For simplicity, server 114 and remote control device 112 are shown within the same wireless network 118.

Remote control device 112 communicates with server 114 via wireless network 118 and is configured to transmit user data (e.g., electronic images, audio clips, video clips) for remote storage on server 114. Remote control device 112 may also be configured to access data previously stored on server 114. In one embodiment, file transfers between remote control device 112 and server 114 may occur via Short Message Service (SMS) messages and/or Multimedia Messaging Service (MMS) messages transmitted via short message service center (SMSC) 124 and/or a multimedia messaging service center (MMSC) 126. Although shown as part of network 118, SMSC 124 and MMSC 126 may be part of another network or otherwise outside of network 118. Although shown as separate logical entities, SMSC 124 and MMSC 126 could be a single entity. Further, SMSC 124 and MMSC 126 may coordinate via signaling between themselves for improving the file transfer process. For example, because SMSC 124 and MMSC 126 may be store-and-forward systems, rather than real-time systems, a file requested via an SMS message from remote control device 112 may still reside on MMSC 126 based upon a previous request. As such, SMSC 124 may copy MMSC 126 on an SMS file request and, if applicable, MMSC 126 may notify the user of the previously stored file. Further, MMSC 126 may simply transfer the requested file based on its stored copy of the file. In other embodiments, MMSC 126 may act as a repository for files, and remote control device 112 may simply request transfer of files from MMSC 126.

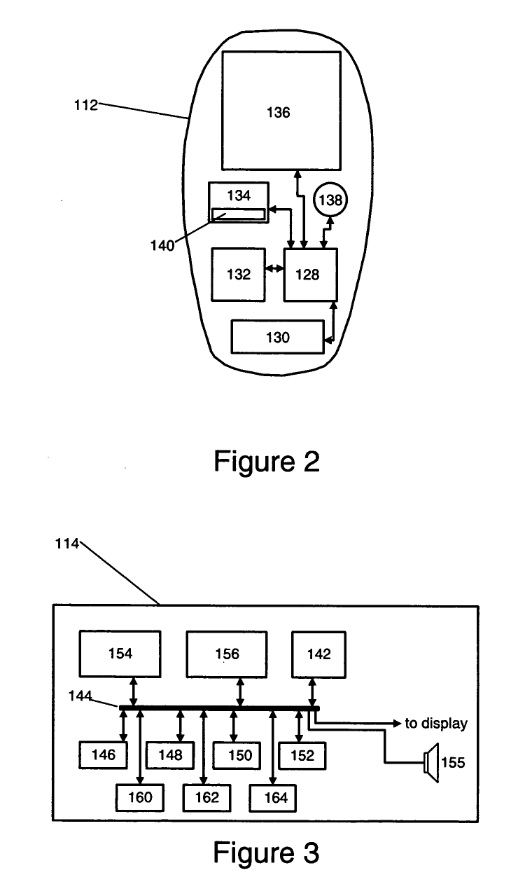

As shown in FIG. 2, remote control device 112 may include processor 128 connected to user interface 130, wireless communications interface 132, memory 134 and/or other storage, display 136, and digital camera 138. User interface 130 may further include a keypad, four arrow keys, joy-stick, data glove, mouse, roller ball, touch screen, voice interface, or the like. Software 140 may be stored within memory 134 and/or other storage to provide instructions to processor 128 for enabling remote control device 112 to perform various functions. For example, software 140 may configure processor 128 to enable remote control device 112 to take digital photographs via digital camera 138, to automatically name a photograph, to save photographs as image files, to transfer image files to server 114, to retrieve and display image files from server 114, and to browse the Internet using communications interface 132. Although not shown, communications interface 132 could include additional wired (e.g., USB) and/or wireless (e.g., BLUETOOTH, WLAN, WiFi or IrDA) interfaces configured to communicate over different communication links.

As shown in FIG. 3, server 114 may include processor 142 coupled via bus 144 to one or more communications interfaces 146, 148, 150, and 152. Interface 146 may be a cellular telephone or other wireless network communications interface. There may be multiple different wireless network communication interfaces. Interface 148 may be a conventional wired telephone system interface. Interface 150 may be a cable modem. Interface 152 may be a BLUETOOTH interface or any other short range wireless connection interface. Additionally, there may be multiple different interfaces. FIG. 3 also illustrates receiver devices such as receiver devices 160, 162, and 164. Receiver device 162 may comprise a television receiver configured to receive and decode transmissions based on Digital Video Broadcast (DVB) standard. Receiver 162 may include a radio receiver such as a FM radio receiver to receive and decode FM radio transmissions. Receiver 164 may comprise an IP datacasting receiver.

Server 114 may also include volatile memory 154 (e.g., RAM) and/or non-volatile memory 156 (such as a hard disk drive, tape system, or the like). Software and applications may be stored within memory 154 and/or memory 156 that provides instructions to processor 142 for enabling server 114 to perform various functions, such as processing file transfer requests (such as for image files), storing files in memory 154 or memory 156, displaying images and other data, and organizing images and other data. The other data may include but is not limited to video files, audio files, emails, SMS/MMS messages, other message files, text files, or presentations. Although shown as part of server 114, memory 156 could be remote storage coupled to server 114, such as an external drive or another storage device in communication with server 114. Preferably, server 114 also includes or is coupled to a display device 158 (FIG. 1) that may have a speaker, via a video interface (not shown). Display 158 may be a computer monitor, a television set, a LCD projector, or other type of display device. In at least some embodiments, server 114 also includes a speaker 155 over which audio clips (or audio portions of video clips) stored in memory 154 or 156 may be played. In some other embodiments, the input device 112 and the display 158, or alternatively the input device 112, the display device 158 and the server 114 may be combined in a same device unit.

A user accesses server 114 directly through a local input device, such as input device 112. Server 114 also displays various user interfaces (e.g., such as are described below) on display device 158 in addition to thumbnails, enlarged images, and other information. Possible input devices 112 include wired and wireless keyboards, mice and remote control units. Remote control device 112 could also communicate with server 114 by BLUETOOTH or other wireless link, or via a cable connection to a port on mobile device 112. In some embodiments, server 114 is accessible remotely via remote control device 112 or (other devices) over wireless network 118, the Internet, or another communication network.

Description of Illustrative Aspects of the Invention

According to an aspect of the invention, a system is provided for manipulating media files stored on a device such as a server 114. The media files may comprise images, video files, audio files, text files, or messages. One example of a media file used throughout the various aspects of the present invention comprises an image such as a digital picture represented as a thumbnail image. Those skilled in the art will realize that the use of thumbnail images throughout the various examples of the present invention is illustrative of one form of media files which may be used with the present invention. The use of thumbnail images in the various illustrations of the present invention is not meant to be limiting to such thumbnail images but is utilized to provide the details of the invention. In addition, although the following description refers to media files received from one or more remote control devices 112, the invention is not limited by data type or source.

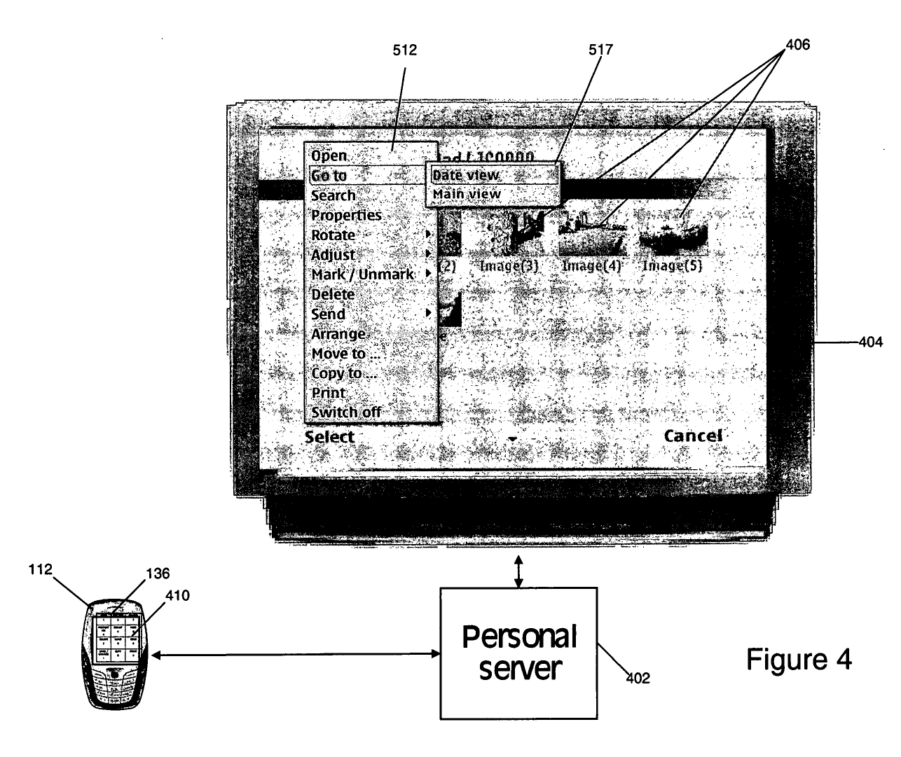

As shown in FIG. 4, a remote control device 112 may transmit media files to be stored in a server such as personal server 402. The media files may have been created by remote control device 112 or remote control device 112 may have received them through a network. For example, remote control device 112 may comprise a digital camera (not shown) which may enable a user to take digital images or photographs of interest to the user. Images created with remote control device 112 may be transmitted to personal server 402 and stored in memory 154 or 156 of personal server 402.

At some later point, a user may access the media files stored within memory 154 or 156 of personal server 402. In one aspect of the invention, a user is able to view executable commands on the remote control device 112 and the display device 404 substantially simultaneously. In another aspect of the invention, a user is able to view the media files on the remote control device 112 and the display device 404 substantially simultaneously. In yet another aspect of the invention, a user is able to view both the media files and the executable command on the remote control device 112 and the display device 404 substantially simultaneously.

In FIG. 4, the media files are represented as thumbnail images 406. Thumbnail images 406 may or may not have been created on a single occasion. For example, a user may transfer collections or multiple thumbnail images 406 from remote control device 112 to personal server 402 on several occasions. The thumbnail images 406 may be in JPEG format or other formats. Furthermore, as those skilled in the art will realize, media files may be represented in formats other than thumbnails 406. The thumbnails 406 transferred from remote control device 112 to personal server 402 may be displayed chronologically based on the order transferred from remote control device 112. In addition, the first thumbnail image transferred may be named consecutively, as for example “Image(1)” whereas the second thumbnail or media file to be transferred may be named “Image(2).”

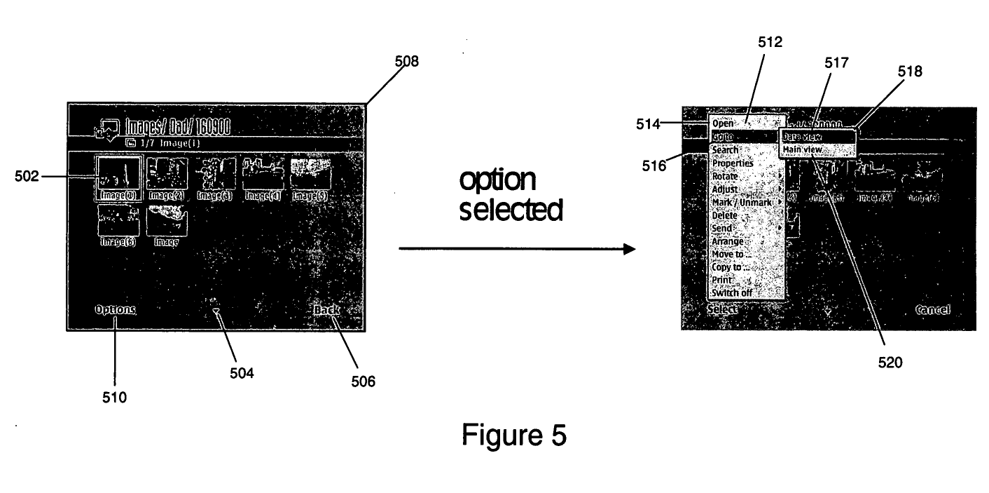

A user utilizing remote control device 112 may highlight a particular thumbnail of interest as shown in FIG. 5. In FIG. 5, a thumbnail 502 entitled “Image(1)” has been selected by a user utilizing remote control device 112. The selection of various thumbnails may be accomplished by moving a selection box using arrow or similar type keys, or joy-stick, on remote control device 112. Although FIG. 5 shows seven thumbnails or media files, it will be appreciated by those skilled in the art that many more images or media files may be displayed on display device 404 (FIG. 4). Accordingly, a page down “arrow” 504 and a page “back” button 506 may be displayed on thumbnail display 508 so that a user can move to additional screens in order to view all of the stored thumbnails or media files.

After a user highlights a particular thumbnail of interest, in one aspect of the invention, a user may enlarge the highlighted thumbnail to be viewed on display device 404. The user may, for example, be reviewing various images that he or she has allowed to accumulate in memory 154 or 156 and deciding which images should be saved and which images discarded. As the user peruses the relatively low-resolution thumbnails, he or she identifies an image of interest and causes the image to be enlarged by highlighting the thumbnail and pressing an “enter” or other appropriate key on the remote control device 112.

In addition to selecting a particular thumbnail image such as thumbnail image 502 in FIG. 5, a user may select an “Options” button 510 on thumbnail display screen 508. The selection of an “Options” or “Menu” button 510 on thumbnail display screen 508 may pull up a command menu 512 that can be selected to be performed on the selected thumbnail image or full image. For example, an “Open” command 514 may be displayed on the command menu 512. The activation of the “Open” command 514 by a user may enlarge the selected thumbnail 502 to view the contents of thumbnail image 502. As another example, a user utilizing remote control 112 may activate a “Go to” command 516 on the command menu 512. The selection of the “Go to” command 516 may present a sub-command menu 517 further associated with the “Go to” command 515. For example, the sub-command menu 517 may present a user with a choice as to whether the user wants to view a “Date view” 518 or a “Main view” 520. For example, the “Date view” 518 command may present to a user a thumbnail display screen which shows the thumbnail images in chronological order whereas as the “Main view” 520 command may display a thumbnail display screen which shows the thumbnails alphabetized by thumbnail image name.

Returning to FIG. 4, in accordance with one aspect of the invention, personal server 402 may transmit to remote control device 112 a command menu 410 that is same, similar or at least partially related to command menu 512. The transmitted command menu 410 may enable a user to issue commands pertaining to a selected media file without having to closely view or concentrate on both the display device 404 and the display 136 (or user interface 130) of remote control device 112. The transmitted command menu 410 may not contain every command that may be executed on a particular media file.

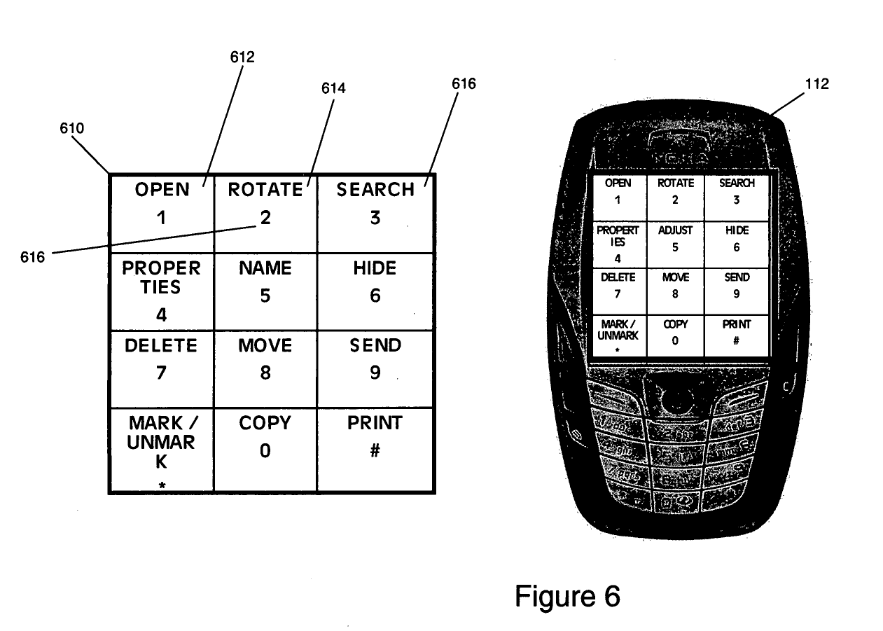

In one aspect of the invention, the command menu 410 may contain only the most frequently used commands for the selected media files. FIG. 6 illustrates one possible command menu 610 that may be used in accordance with one aspect of the present invention. In FIG. 6, a command menu 610 may provide the most frequently used commands associated with a highlighted object on display device 404. For example, command menu 610 may be associated with a highlighted thumbnail image such as thumbnail image 502 (FIG. 5) named “Image(1).” For a highlighted thumbnail image such as thumbnail image 502, the command menu 610 may display commands such as an “OPEN” command 612 and a “ROTATE” command 614. Each of the commands displayed on display 136 of remote control device 112 may be interlinked or associated with a button found on remote control device 112. For example, the “ROTATE” command 614 may be interlinked with a number “2” button found on remote control device 112. In other words, the command menu 610 may display a mapping of commands to buttons found on remote control device 112. The activation of the corresponding button on remote control device 112 may perform the command on objects highlighted on display screen 404 such as thumbnail image 502. In another embodiment, the commands may be displayed on a touch screen display, so that the commands are interlinked or associated with that area of the touch screen.

In one aspect of the invention the command menu 512 may only give an indication or notification to a user that the command menu 410 has been transmitted to the remote control device 512. The indication may include an icon, text or both.

As indicated above, only the most frequently used commands may be displayed on display 136 of remote control device 112. Personal server 114 or an application running on personal server 114 may alter the user interface, such as content, features or appearance of the user interface, displayed on remote control device 112 based on the object highlighted in display screen 404. In addition, the application running on personal server 114 may also recognize when sharing of a menu or user interface is convenient for a user. This may be automatic and preinstructed by the application program, e.g. by content or file type, or a user may ask the application to share the menu or the user interface

In one embodiment of the invention, the server 114 may recognize the remote control device and technical capabilities of the remote control device. The technical capabilities may include, but are not limited to, size and resolution of the display, type of the display, style of a keyboard, key buttons that are used in the user interfaces, and style of the user interface. Alternatively, the remote control device may itself transmit instructions regarding how to modify the menu.

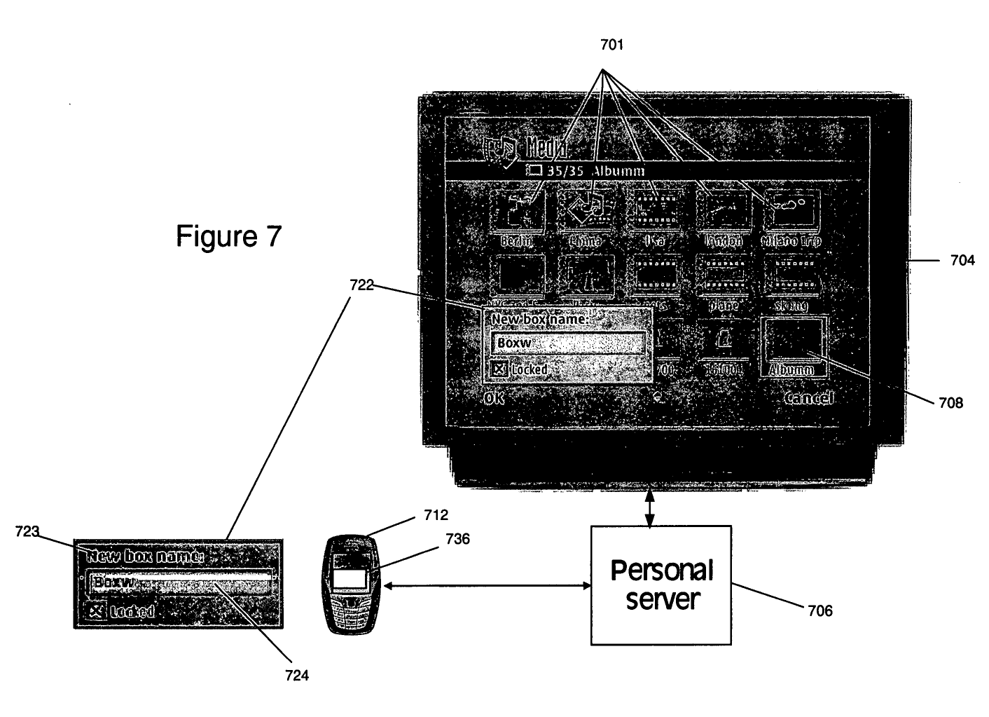

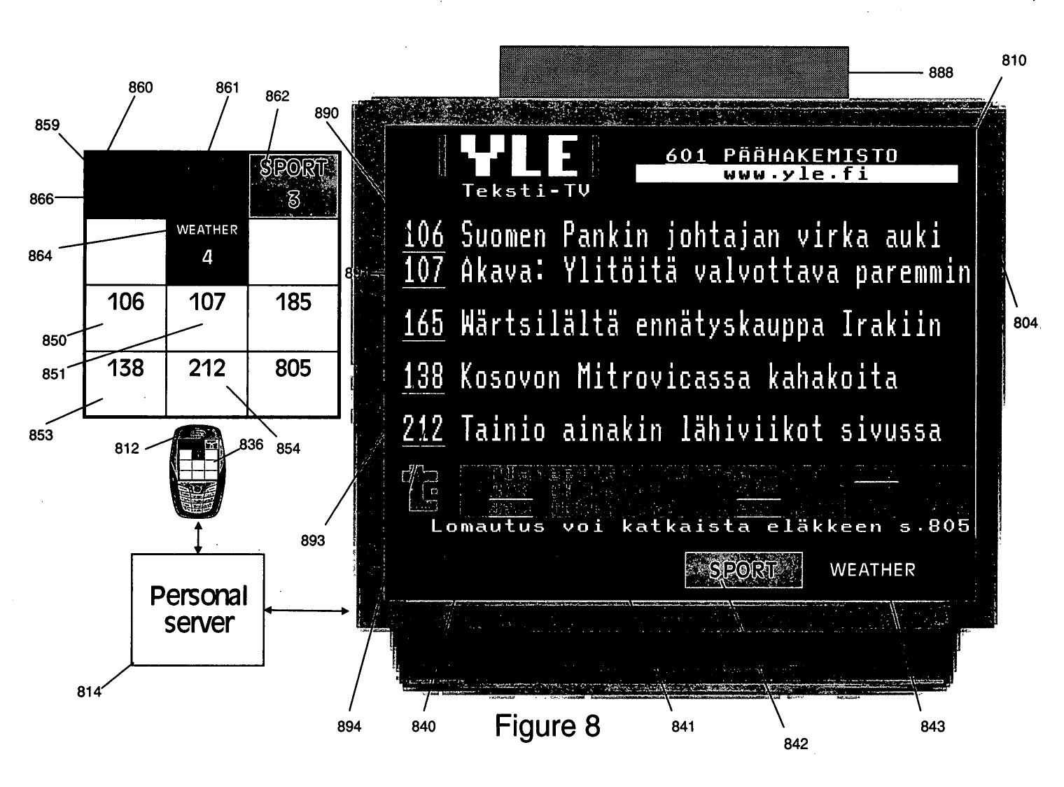

FIG. 7 shows a system for interacting with media files in accordance with another aspect of the present invention. In FIG. 7, a user has transmitted a group of media files such as thumbnail images 701 to personal server 706 from remote control device 712. The thumbnail images 701 may be displayed on display device 704. In FIG. 7, a user may want to rename a folder which may contain a thumbnail image or numerous related thumbnail images. A folder may be used to store media files which a user may wish to view simultaneously. Folders may allow a user to create categories of media files to help a user organize and search his or her collection of media files.

In FIG. 7, a folder 708 has been given the name “Albumm.” A user wishing to change the name of folder 708 may first move a cursor over folder 708 by using key buttons or a joystick found on remote control device 712 in order to highlight folder 708. A user may select folder 708 by pressing a menu button on remote control device 712 or by pressing an enter key on remote control device 712. Those skilled in the art will realize that numerous ways exist for a user to activate a menu for a selected object.

Upon pressing a menu button, a menu with commands associated with folder 708 may be substantially simultaneous displayed on display device 704 and on remote control device 712. The menu with commands for remote control device 712 may be adjusted to be properly displayed on smaller display screen 736 of remote control device 712. The menu commands displayed on display screen 736 may be interlinked to keyboard buttons found on remote control device 712. In another aspect of the invention, the remote control device 712 may include a touch sensitive screen in which the activation of a particular command may be accomplished by touching the screen with a pointing device in a particular area of the screen.

For example, a command menu may include a “Name” command that is interlinked to a keyboard button 5 similar to the command menu 610 found in FIG. 6. Upon activation of a “Name” command by a user, a dialog box 722 may open substantially simultaneously on the display device 704 and on the display 736 of remote control device 712. A user wanting to change the name of a folder 708 may begin to enter a new name for folder 708 using the buttons on remote control device 712. Typing of the new name for folder 708 may be further enhanced by using a predictive text input system, such as T9. The user entering the new name of folder 708 may not need to view display screen 704 while entering the new name of folder 708 as the display 736 contains all the information needed to accomplish the name change. For example, the dialog box 722 on remote control device 712 may include a field entitled “New box name:” 723 for entry of the new folder name. As shown in FIG. 7, a user may change the name of folder 708 from “Albumm” to “Boxw” upon entry of the new name into text box field 724. Similar to the name change command, a user may perform various other commands such as delete, move, send, hide, search, properties, print, copy, and/or mark/unmark. Those skilled in the art will realize that numerous other commands may be listed in a command menu. In addition, the commands displayed in the command menu may change based on the object highlighted in display screen 704.

FIG. 8 illustrates another aspect of the present invention. In FIG. 8, a personal server 814 may transmit a signal such as a television signal to a television receiver 804. The television receiver 804 may be an Internet Protocol Datacasting (IPDC) receiver. In another embodiment, the personal server 814 may first transmit the television signal to a set-top box 805. The television broadcast may include interactive services complying with the Multimedia Home Platform (DVB-MHP) standard or any other DVB or digital television broadcasting standard. In addition, vertical blanking interval transmission, such as Teletext, Text-TV or Super Teletext services, may be utilized.

In MHP (Multimedia Home Platform) applications, Text-TV or Super Teletext transmission, a four colored button system may be utilized to receive additional information on various subjects. FIG. 8 illustrates the aspects of the invention in a Text-TV context. In FIG. 8, colored buttons such as MENU button 840, NEWS button 841, SPORT button 842, and WEATHER button 843 are shown in display device 804 in a command menu 810.

A similar command menu 859 may also be located on a display 836 of remote control device 812. The command menu 859 may enable a user to issue commands pertaining to a selected media file or Text-TV content without having to closely view both the display device 804 and the display 836 of remote control device 812. The transmitted command menu 810 may not contain every command that may be executed on a particular Text-TV application.

In one aspect of the invention, the command menu 859 may contain only the most frequently used commands such as MENU button 860, NEWS button 861, SPORT button 862, and WEATHER button 864. In addition, remote control device 812 may also comprise shortcut commands on the command menu 860 for various programs. The shortcuts may provide additional information about the program being presented. For example, television receiver 804 may comprise various links to program information such as links 106, 107, 165, 138 and 212.

Each of the commands displayed on display 836 of remote control device 812 may be interlinked with a button found on remote control device 812. For example, the “MENU” command 860 may be interlinked with a number “1” button 866 found on remote control device 812. In other words, the command menu 860 may display a mapping of commands to buttons found on remote control device 812. The activation of the corresponding button on remote control device 812 may perform the command such as to provide additional information regarding world news or sports. In another aspect of the invention, the remote control device 812 may include a touch sensitive screen in which the activation of a particular command may be activated by touching the screen with a pointing device in a particular area of the screen.

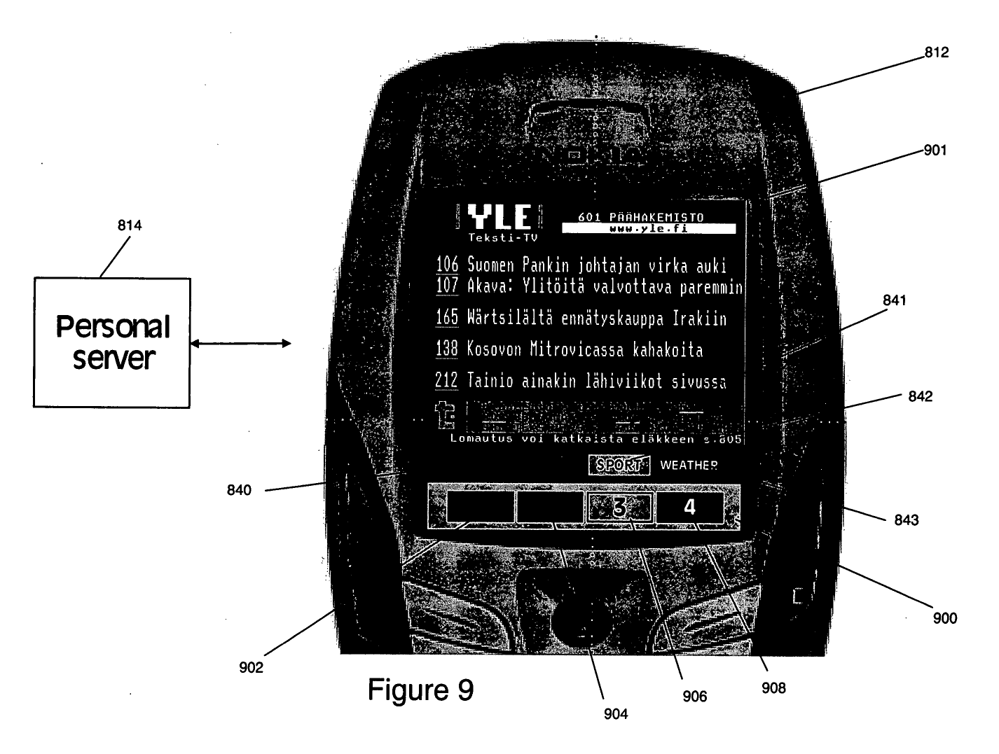

In another aspect of the invention, the broadcasting content may only be displayed on a display of a remote control device. For instance in FIG. 9, a personal server 814 may transmit a signal such as a television signal to remote control device 812. The remote control device 812 may be an Internet Protocol Datacasting (IPDC) receiver. As stated above, in MHP (Multimedia Home Platform) applications, Text-TV or Super Teletext transmissions, a four colored button system may be utilized to receive additional information on various subjects. FIG. 9 illustrates the aspects of the invention in a Text-TV context. In FIG. 9, colored buttons such as MENU button 840, NEWS button 841, SPORT button 842, and WEATHER button 843 are shown in display 901 of remote control device 812. A similar command menu 900 may also be located on a display 901 of remote control device 812. The command menu 900 may be interlinked with the buttons as shown in FIG. 9. For example, a first button “1” (902) may correspond to MENU button 840. Similarly, a second button “2” (904) may correspond to a NEWS button 841. Furthermore, a third button “3” (906) and fourth button “4” (908) may also correspond to a SPORTS button 842 and a WEATHER button 843, respectively.

As can be appreciated from the preceding description, embodiments of the invention allow a user to browse, select, or edit displayed media files in a convenient manner. Moreover, the invention is not limited to organization of data for still images. Although the above description used still images as examples, the invention is equally applicable to video clips. Alternatively (and in the case of audio clips), the user can be presented with a display of icons or list of file names as the “thumbnail” interface. Additionally, folders, albums or collections of files may be manipulated by same way as media files described in this invention.

FIG. 1 described above illustrates an embodiment in which the data or media files are stored in a portable personal server 114. In another embodiment, the data files may be stored in a network server that is preferably a service by a service provider. A user may now access the server and present, edit, or manipulate the data files by using their mobile communication device (or wireline communication device like a PC computer) by the same manner as described throughout the specification. The network server may receive the data files from the user's mobile communication device (or from PC computer) or from any other source, such as photo service provider, or music or video service provider. The user may access the server and service with their mobile communication device through a wireless network, such as wireless telecom network, WLAN, Bluetooth, or similar wireless protocol. Commands for presenting, manipulating and editing the data files are transmitted through the network. The selected data files are also retrieved for presentation through the network if a user display is attached in the user's mobile communication device. Alternatively, when the user display is separate from the user's mobile communication device, such as a TV device, set-top box, personal computer, the selected data files may directed to the display device through a second communication network (wireless or wireline).

While illustrative systems and methods as described herein embodying various aspects of the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Also, the invention has been defined using the appended claims; however these claims are exemplary in that the invention is intended to include the elements and steps described herein in any combination or sub-combination. It will also be appreciated and understood that modifications may be made without departing from the true spirit and scope of the invention.

We claim:

1. A system for manipulating and interacting with media files, the system comprising:
at least one display device having a first display;
at least one remote control device, the remote control device comprising a second display; and
a computer readable medium having computer executable instructions for performing the steps of:
displaying a first user interface on the first display and a second user interface on the second display, the second user interface displayed on the remote control device, the second user interface at least partly related to the first user interface displayed on the at least one display device, the second interface capable of receiving executable commands; and
receiving an executable command from the second user interface of the remote control device to manipulate the media files.

2. The system of claim 1, further comprising displaying the manipulated media files on the first display.

3. The system of claim 1, wherein the second user interface includes at least part of the executable commands of the first user interface displayed on the at least one display device.

4. The system of claim 1, wherein the first user interface and the second user interface are similar.

5. The system of the claim 1, wherein the first user interface displays an indication that the second user interface is transmitted to the remote control device.

6. The system of claim 1, wherein the second user interface displayed on the second display of the remote control device includes a dialog box.

7. The system of claim 6, wherein a user enters at least one character as an executable command into the dialog box displayed on the second user interface of the remote control device.

8. The system of claim 7, wherein the at least one character entered by the user is substantially simultaneously displayed on both the first display and the second display of the remote control device.

9. The system of claim 1, wherein the second user interface displayed on the second display of the remote control device comprises a menu with executable commands.

10. The system of claim 9, wherein the executable commands on the second user interface are associated with key buttons of the remote control device.

11. The system of claim 1, wherein the second user interface displayed on the remote control device includes buttons associated with executable commands.

12. The system of claim 1, wherein the remote control device comprises a mobile communication device.

13. The system of claim 12, wherein the mobile communication device comprises a cellular telephone.

14. The system of claim 1, wherein the media files comprise images.

15. The system of claim 1, wherein the media files comprise text files or messages.

16. The system of claim 1, wherein the media files comprise video files.

17. The system of claim 1, wherein the manipulated media files are substantially simultaneously displayed on both the first display and the second display.

18. A system for interacting with media files, the system comprising:
(a) at least one display device having a first display;
(b) a remote control device, the remote control device, including:
(1) a digital camera;
(2) a memory for storing the media files, the media files created with the digital camera,
(3) a second display; and
(4) a first communication interface with a wireless communication network for transmission of the media files stored in the memory; and
(c) a server, the server including:
(1) a second communication interface through which the media files are received from the remote control device via the wireless communication network;
(2) a server memory for storing the media files received through the communication interface; and
(3) a processor configured to perform the steps of:
transmitting a user interface to both the at least one display device and the remote control device, the user interface displayed on the first display and the second display, the user interface displayed on the remote control device capable of receiving executable commands, the executable commands for manipulating the media files;
receiving through the second communication interface an executable command from the remote control device to manipulate the media files; and
transmitting the manipulated media files to both the first display and the second display.

19. The system of claim 18, wherein the manipulated media files are substantially simultaneously displayed on both the first display and the second display.

20. The system of claim 18, wherein the processor transmits the user interface and the manipulated media files through a short-range wireless communication network.

21. The system of claim 20, wherein the short-range communication network comprises Bluetooth.

22. The system of claim 18, wherein the user interface displayed on the second display of the remote control device includes a dialog box.

23. The system of claim 22, wherein a user enters at least one character into the dialog box displayed on the user interface of the remote control device.

24. The system of claim 23, wherein the at least one character entered by the user is substantially simultaneously displayed on both the first display and the second display of the remote control device.

25. The system of claim 18, wherein the remote control device comprises a mobile communication device.

26. The system of claim 25, wherein the mobile communication device comprises a cellular telephone.

27. The system of claim 18, wherein the server comprises a set top box.

28. The system of claim 18, wherein the at least one display device comprises a television receiver.

29. The system of claim 18, wherein the remote control device comprises a mobile communication device.

30. The system of claim 29, wherein the mobile communication device comprises a cellular telephone.

31. The system of claim 18, wherein the media files comprise images.

32. The system of claim 183, wherein the media files comprise video files.

33. A computer-readable medium having computer-executable instructions for performing the steps of:
displaying a first user interface on a first display of a display device;
displaying a second user interface of a second display of a remote control device, the second user interface at least partly related to the first user interface displayed on the first display;
receiving an executable command from the second user interface of the remote control device to manipulate media files; and
displaying manipulated media files on the first display of the display device and on the second display of the remote control device.

34. The computer-readable medium of claim 33, wherein the second user interface displayed on the second display of the remote control device includes a dialog box.

35. The computer-readable medium of claim 34, wherein a user enters at least one character as an executable command into the dialog box displayed on user interface of the remote control device.

36. The computer-readable medium of claim 35, wherein the at least one character entered by the user is substantially simultaneously displayed on the first display of the display device and on the second display of the remote control device.

37. The computer-readable medium of claim 33, wherein the second user interface displayed on the second display of the remote control device comprises a menu with executable commands.

38. The computer-readable medium of claim 37, wherein the executable commands on the second user interface are associated with key buttons of the remote control device.

39. The computer-readable medium of claim 33, wherein the second user interface displayed on the remote control device includes buttons associated with executable commands.

40. The computer-readable medium of claim 33, wherein the remote control device comprises a mobile communication device.

41. The computer-readable medium of claim 40, wherein the mobile communication device comprises a cellular telephone.

42. The computer-readable medium of claim 33, wherein the manipulated media files are substantially simultaneously displayed on the first display of the display device and on the second display of the remote control device.

43. A server for interacting with media files, the server comprising:
a memory;
a communications interface through which media files stored on a remote control device may be transferred to the memory; and
a processor configured to perform steps comprising:
transmitting a first user interface to a first display of a first display device;
transmitting a second user interface to a second display of a remote control device, the second user interface displayed on second display of the remote control device, the second user interface capable of receiving executable commands;
receiving through the communication interface an executable command from the second user interface of the remote control device to manipulate the media files; and
transmitting the manipulated media files to the first user interface of the first display of the display device and to the second user interface of the second display of the remote control device.

44. The server of claim 43, wherein the user interface displayed on the second display of the remote control device includes a dialog box.

45. The server of claim 44, wherein a user enters at least one character into the dialog box displayed on user interface of the remote control device.

46. The server of claim 45, wherein the at least one character entered by the user is substantially simultaneously displayed on the first display of the display device and on the second display of the remote control device.

47. The server of claim 43, wherein the remote control device comprises a mobile communication device.

48. The server of claim 47, wherein the mobile communication device comprises a cellular telephone.

49. The server of claim 43, wherein the manipulated media files are substantially simultaneously displayed on the first display of the display device and on the second display of the remote control device.

50. The server of claim 43, wherein the second user interface displayed on the second display of the remote control device comprises a menu with executable commands.

51. The server of claim 50, wherein the executable commands on the second user interface are associated with key buttons of the remote control device.

52. The server of claim 43, wherein the second user interface displayed on the remote control device includes buttons associated with executable commands.

53. In a media system having a first and second user interface, a method of manipulating a media file, comprising the steps of:
displaying the first user interface on a first display and the second user interface on a second display, the second user interface displayed on a remote control device, the second user interface at least partly related to the first user interface displayed on the display device, the second interface capable to receive executable commands;
receiving an executable command from a user selection to manipulate the media file; and
displaying the manipulated media file on the second display of the remote control device.

54. A network server for interacting with media files, the network server comprising:
a memory;
a communications interface through which media files stored on a remote control device may be transferred to the memory; and
a processor configured to perform steps comprising:
transmitting a first user interface to a first display of a first display device;
transmitting a second user interface to a second display of a remote control device, the second user interface displayed on second display of the remote control device, the second user interface capable of receiving executable commands;
receiving through the communication interface an executable command from the second user interface of the remote control device to manipulate the media files;
storing the manipulated media files in the memory; and
transmitting the manipulated media files to the first user interface of the first display of the display device and to the second user interface of the second display of the remote control device.

55. The network server of claim 54, wherein the user interface displayed on the second display of the remote control device includes a dialog box.

56. The network server of claim 55, wherein a user enters at least one character into the dialog box displayed on user interface of the remote control device.

57. The network server of claim 56, wherein the at least one character entered by the user is substantially simultaneously displayed on the first display of the display device and on the second display of the remote control device.

58. The network server of claim 54, wherein the manipulated media files are substantially simultaneously displayed on the first display of the display device and on the second display of the remote control device.

59. The network server of claim 54, wherein the second user interface displayed on the second display of the remote control device comprises a menu with executable commands.

60. The network server of claim 59, wherein the executable commands on the second user interface are associated with key buttons of the remote control device.
